(19) United States
(12) Patent Application Publication
(10) Pub. No.: US 2024/0246005 A1
(43) Pub. Date: Jul. 25, 2024

(54) LIGHT MATRIX BUILDING BLOCK FOR A MODULAR TOY OR EDUCATIONAL CONSTRUCTION SET

(71) Applicant: LEGO A/S, Billund (DK)

(72) Inventors: Oliver WALLINGTON, Billund (DK); Per CHRISTOFFERSEN, Billund (DK)

(73) Assignee: LEGO A/S, Billund (DK)

(21) Appl. No.: 18/552,020

(22) PCT Filed: Mar. 24, 2022
(86) PCT No.: PCT/EP2022/057791

§ 371 Date: Sep. 22, 2023

(30) Foreign Application Priority Data
Mar. 25, 2021 (DK) PA202170131

(51) Int. Cl. A63H 33/22; A63H 33/04; G09B 5/02

(52) U.S. Cl. CPC A63H 33/22; A63H 33/042; G09B 5/02; A63H 2200/00

(57) ABSTRACT

A light matrix building block for a modular toy or educational construction set, which comprises a plurality of separate light emitting elements and is configured to control the colour and intensity of each of the light emitting elements individually, and receive and decode digital information to regulate the colour and intensity of each of the light emitting elements, wherein the digital information to regulate the colour and intensity of a light emitting element in the plurality of light emitting elements is encoded in a single byte of information. Also, a modular toy or educational construction set comprising the light matrix building block and a building block device, and a method of communication between a light matrix building block and a building block device.

### CROSS-REFERENCE TO RELATED APPLICATIONS

The present application is a U.S. National Stage Application of International Application No. PCT/EP2022/057791, filed on Mar. 24, 2022 and published on Sep. 29, 2022 as WO 2022/200510 A1, which claims the benefit and priority of Danish Patent Application No. 202170131, filed on Mar. 25, 2021, each of which is incorporated herein by reference in its entirety for any purpose whatsoever.

### FIELD OF THE DISCLOSURE

The present disclosure relates to building blocks for a modular toy or educational construction set, in particular to a light matrix building block having a plurality of separate light emitting elements, a modular toy or educational construction set comprising a light matrix building block and a building block device electronically connected with each other, and a method of communication between a light matrix building block and a building block device.

### BACKGROUND

Modular toy or educational construction sets provide a way for young children, adolescents and adults alike to play and experiment by exploring and utilising the ways in which the modules may be put together.

More and more of such construction sets have building blocks comprising electronic parts, which may electronically connect with each other and comprise building blocks, which are also sensors, batteries, actuators, light modules, etc. A challenge for modular construction sets comprising electronic parts is size and durability. The electronic parts often need to have a small form factor, and the modules are required to withstand being assembled and dissembled numerous times.

To facilitate play and learning the different modules should be able to fit together in multiple ways and, where needed, to exchange digital information quickly such that the play or learning experience is smooth and uninterrupted. For some electronic modules the digital communication between them or to/from an app may with some advantages be made using a wireless communication protocol, which has the disadvantage of being slower than a wired connection. A construction which is capable of communicating information to and from the user, for example via an app, or via sensory outputs from one or more building blocks, such as e.g. vibration, sound or light, requires a significant amount of digital information to be transmitted.

There is thus a need for modules for modular toy or educational construction sets to be able to communicate information to each other quickly, and for modules, which can connect with each other in a variety of ways.

### SUMMARY

It is an object of some embodiments to solve or mitigate, alleviate, or eliminate at least some of the above or other challenges.

In a first aspect is provided a light matrix building block for a modular toy or educational construction set, in a second aspect is provided a modular toy or educational construction set comprising a light matrix building block according to the first aspect and a building block device, and in a third aspect is provided a method of communication between a light matrix building block and a building block device. In the different aspects, the features having the same name have a similar function and therefore the descriptions and explanations of features in any aspect apply to those features in any another aspect.

According to the first aspect is provided a light matrix building block for a modular toy or educational construction set. The light matrix building block comprises a plurality of separate light emitting elements and is configured to:
control the colour and intensity of each of the light emitting elements individually, and
receive and decode digital information to regulate the colour and intensity of each of the light emitting elements,
wherein the digital information to regulate the colour and intensity of a light emitting element in the plurality of light emitting elements is encoded in a single byte of information.

A building block for a modular construction set has one or more attachment parts designed to allow the building block to interlock with one or more other building blocks. The attachment parts of different building blocks may be similar or may be different, but designed so as to allow the building blocks to adhere to or grip each other. The light matrix building block may, for example, interlock with one or more simple non-electronic building blocks, one or more other light matrix building block and/or other building blocks comprising electronic parts.

The plurality of light emitting elements may be arranged on a 2D grid such as a grid defining, for example, a rectangle, a square, a circle, etc. If the grid is in a rectangular or square shape, the light matrix may be a square matrix, i.e. have the same number of lights in its rows and columns, e.g. a 2×2, 3×3, 4×4, etc. The separate light emitting elements may be LEDs, and they may be of the same type and/or model, or different.

As the colour and intensity of each of the light emitting elements is controlled individually, some or all of the light emitting elements may be on or off at a given time.

The light matrix building block can receive digital information and has processing power to decode the digital information to regulate the colour and intensity of each of the light emitting elements, for example as requested directly by a user or by a software program. By regulate is meant that the colour and intensity is set appropriately, i.e. the colour may be changed, the intensity may be increased or decreased, or the light turned off (intensity=zero).

The digital information to regulate the colour and intensity of each individual light emitting element is encoded in a single byte of information, which allows the light matrix building block to quickly and, at least to the human eye, simultaneously regulate the colour and intensity of all of the plurality of light emitting elements in response to the information encoded in the single byte, i.e. 8 bits, of information. To increase the number of colours available and reduce the bits needed to provide the coded information to regulate intensity and colour, the intensity and colour coded information may be provided as an indexed intensity and indexed colour, respectively. For example, the intensity coded information and colour coded information may each be encoded in 4 bits.

The light matrix building block may be configured to receive the digital information wirelessly or via a wired connection. A wired connection may be formed as part of the one or more attachment parts, which allow the light matrix building block to interlock with other building blocks, or it may be, for example, an electric cable with a connector at the end for electronically connecting to another entity. The light matrix building block may connect with a building block device, i.e. a building block comprising electronic parts and having a technical function, such as e.g. a battery, a sensor, etc. When the light matrix building block is connected to a building block device, it may act and respond in a suitable manner. To this end, the light matrix building block may be further configured to determine whether an electronically connected building block device can provide power to a connected building block, and whether the connected building block device is configured for digital communication. For example, the light matrix building block may regulate the colour and intensity of each of the light emitting elements according to a status of a connected building block device such as: power level of a battery, polarity of power supplied, sensor value, whether device is on/off, transmitting, recording, updating, etc.

According to the second aspect, a modular toy or educational construction set comprising a light matrix building block according to the first aspect and a building block device is provided. The light matrix building block and the building block device are each configured to be electronically connected with each other.

In an embodiment, the building block device is a building block hub device, which is configured to encode digital information intended for the light matrix building block. A hub device can connect, wirelessly or cabled, to a plurality of other devices and transfer data between the devices connected to it. If the light matrix building block is not capable of wireless communication, it may be connected via a cable to a hub device that is configured for wireless communication, which can then transfer data it has received wirelessly to the light matrix building block. Thus, in an embodiment, the building block device is a hub device, which is configured to wirelessly receive digital information intended for the light matrix building block. Advantageously, the wireless communication, which the hub device is configured for, could be Bluetooth Low Energy (BLE) as this considerably reduces power consumption partially because of the small packets transmitted compared to classic Bluetooth, while maintaining a similar communication range to that of classic Bluetooth. In the Bluetooth 4.0 Low Energy packet structure, the maximum payload in a single message is 20 bytes. In the Bluetooth 4.2 and 5.0 Low Energy packet structure, the maximum payload, i.e. maximum number of bytes used for message content, in a single message is 246 bytes when using so-called Data Length Extension (DLE). Using DLE will, however, lead to longer airtime, which increases the chance of a transmission failing and packets needing to be retransmitted. The longer a Bluetooth message is, the more time it will take to transmit, and therefore, for fast and reliable transmission it is advantageous to reduce the size of the BLE message. Thus, in an embodiment, the building block hub device is further configured to receive the digital information intended for the light matrix building block as a single Bluetooth Low Energy (BLE) message. This synergizes well with the colour and intensity of a light emitting element being encoded in a single byte of information.

In another embodiment, the building block device is a building block battery device, i.e. is a building block and therefore has attachment parts, which allow it to interlock with other building blocks having suitable attachment parts, and it is a battery device. A battery device stores energy and is able to supply power to building block devices connected to it. Some building block battery devices will further be configured for digital communication and will then be referred to as a smart battery device. The light matrix building block may be further configured to detect that it is connected to a battery device. In some embodiments, the light matrix building block is further configured to detect whether a device it is connected to is configured for digital communication. In some embodiments, the light matrix building block is further configured to detect the polarity of a connected battery device.

According to the third aspect, a method of communication between a light matrix building block and a building block device is provided. The light matrix building block comprises a plurality of separate light emitting elements, and is configured to control the colour and intensity of each of the light emitting elements individually. The method comprises:
providing, by the building block device, digital information to the light matrix building block,
receiving and decoding, by the light matrix building block, of the digital information provided by the building block device,
regulating, by the light matrix building block, the colour and intensity of each of the light emitting elements according to the received digital information,
wherein the digital information to regulate the colour and intensity of a light emitting element in the plurality of light emitting elements is encoded in a single byte of information.

In an embodiment, the intensity and colour coded information is provided as an indexed intensity and indexed colour, respectively.

In another embodiment, the intensity coded information and colour coded information are each encoded in 4 bits.

Additional features and advantages will be made apparent from the following detailed description with reference to the accompanying drawings.

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity or several physical components can be included in one functional block or element. Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1 shows a drawing of a light matrix building block according to an embodiment,

FIGS. 2-5 shows schematic drawings of a light matrix building block and a building block device according to some embodiments, and

FIG. 6 shows a flow diagram of a method of communication between a light matrix building block and a building block device according to some embodiments.

### DETAILED DESCRIPTION

The subject technology overcomes many of the prior art problems associated with lighting for modular toy or educational construction sets. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left and the like, are used with respect to the figures and not meant in a limiting manner.

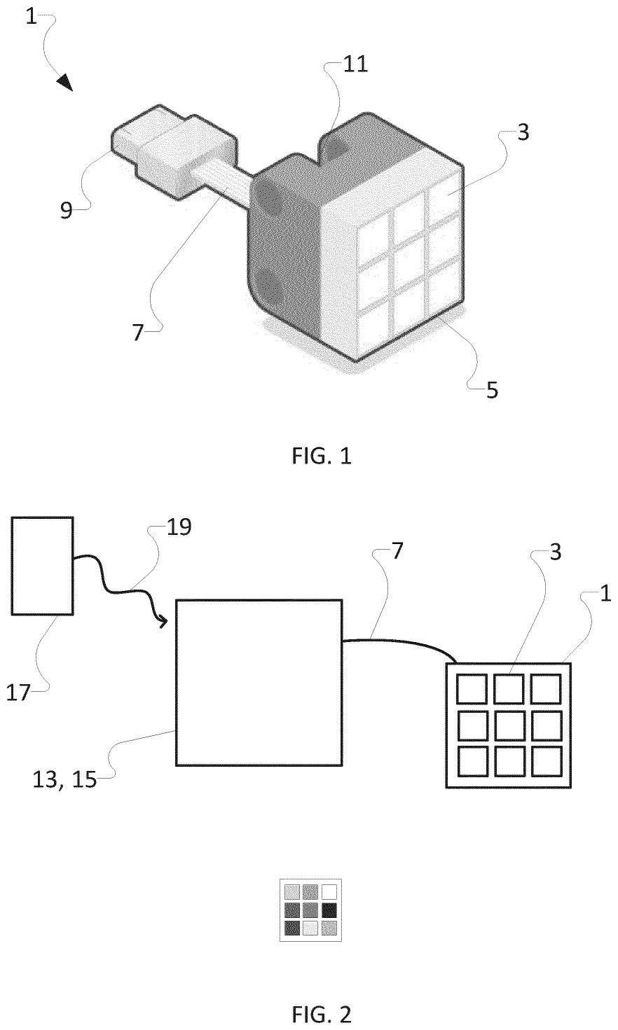

FIG. 1 shows a drawing of a light matrix building block 1 according to an embodiment. The light matrix building block 1 has a 3×3 matrix 5 of separate LEDs totalling nine light emitting elements 3. The light matrix building block has various attachment parts Il allowing it to interlock with other building blocks having suitable attachment parts. A connection cable 7 with a connector 9 at the end enables the light matrix building block 1 to electronically connect with another device and allows for power to be supplied to the light matrix building block 1 as well as digital communication between connected devices, if supported.

The colour and intensity of each of the light emitting elements 3 can be controlled individually by a controller within the light matrix building element 1. The light emitting elements 3 can produce a plurality of colours at a plurality of intensities, where both colour and intensity are controlled separately for each light emitting element 3. The digital information containing the instructions on the colour and intensity setting for each light emitting element 3 is provided to the light matrix building block 1 via the connection cable 7 or via a wireless connection. To enable the light matrix 5 to update quickly even where the digital information encoding for colour and intensity of each light emitting element 3 is transmitted using the Bluetooth Low Energy protocol, either directly to the light matrix building block 1 or to a device connected to the light matrix building block via the connection cable 7, the digital information to regulate the colour and intensity of a light emitting element is encoded in a single byte. After receiving the digital information, the light matrix building block 1 decodes the nine bytes of data required to update the colour and intensity setting of the nine LEDSs in the light matrix 5.

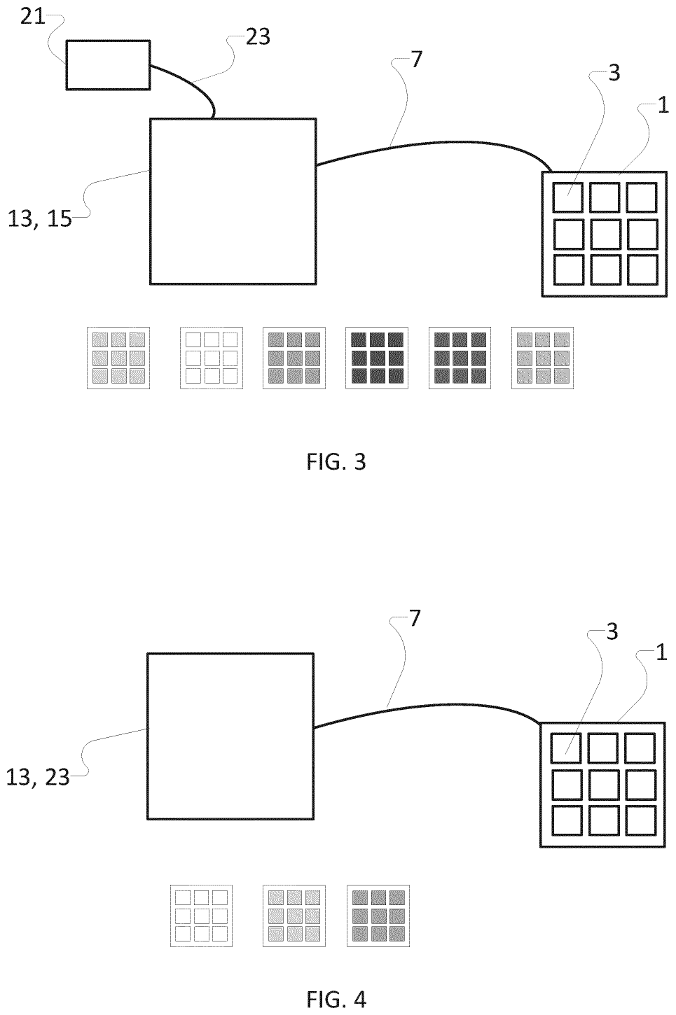

FIGS. 2-5 show schematic drawings of a light matrix building block 1 and a building block device 13 according to some embodiments. In connection with each figure will be described a way in which a light matrix building block 1 via its light emitting elements can be used to provide a desired visual output. The visual output may be perceived by a person or received by a device, e.g. a camera, or a sensor.

FIGS. 2-5 show schematic drawings of a light matrix building block 1 and a building block device 13 connected through a wired connection 7. As in the embodiment shown in FIG. 1, the light matrix building block 1 has a 3×3 matrix 5 of separate LEDs 3 totalling nine light emitting elements 3. The building block device 13 is an electronic device that is also a building block, i.e. it has attachment parts (not shown), which allow it to interlock with other building blocks having suitable attachment parts.

The building block device 13 in FIGS. 2 and 3 is a building block hub device 15, which can communicate with, and facilitate communication between, the light matrix building block 1 and other devices such as e.g. other building block devices, tablets, computers, mobile phones etc. A building block hub device 15 can generally be configured for either wired or wireless communication, or both. Thus, it is able to receive digital information intended for the light matrix building block 1.

In the embodiment in FIG. 2 the building block hub device 15 is connected to a tablet 17 via a wireless connection 19 using the BLE protocol through which it receives instructions intended for the light matrix building block 1. The hub device 15 transmits the digital information it received from the tablet 17 to the light matrix building block 1 via the connection cable 7, the light matrix building block 1 decodes the information and regulates the colour and intensity of each light emitting element 3 accordingly.

The information from the tablet 17 is transmitted using the BLE protocol, and the tablet 17 could instead be e.g. a computer, or other building block device capable of communicating wirelessly using the BLE protocol. By encoding the information for each light emitting element 3 in a single byte, it is possible to update all nine light emitting elements 3 of the light matrix 5 using a single BLE message, which allows for a quick update.

Below the schematic of the hardware in FIG. 2 is illustrated the light matrix 5 with the LEDs 3 all having different colours and different intensities, which is possible because all the light emitting elements 3 are controlled individually. The colours could be e.g. light blue, red, yellow, green, blue, purple, teal, pink, white, etc., which is illustrated as different shades of grey. The setup shown in FIG. 2 allows for a fast and reliable high level of control of the light matrix 5.

As an example, the colour and intensity of each light emitting element 3 may be provided in the encoding as an indexed intensity and indexed colour, respectively, where four bits could provide the index for the colour and four bits provide the index for the intensity:

| Intensity | | | | Colour | | | |
|---|---|---|---|---|---|---|---|
| Bit 7 | Bit 6 | Bit 5 | Bit 4 | Bit 3 | Bit 2 | Bit 1 | Bit 0 |
| 0/1 | 0/1 | 0/1 | 0/1 | 0/1 | 0/1 | 0/1 | 0/1 |

Each of the values of the colour index corresponds to a particular distinct colour. The intensity index, however, could be provided as a gamma-level table with the four bits providing the index for the level, such as (for an index with 10 standard intensity levels):

| Level | 1 | 2 | 3 | 4 | 5 | 6 | 7 | 8 | 9 | 10 | OFF |
|---|---|---|---|---|---|---|---|---|---|---|---|
| Factor | 2 | 6 | 14 | 27 | 45 | 69 | 101 | 140 | 189 | 255 | 0 |

To calculate the final RGB-value, the intensity factor is divided by its max and multiplied with each RGB-value, i.e. in the example above the intensity is calculated as factor/255 and then multiplied with each RGB value. For example, if the colour selected has RGB=(0, 160, 30) and the intensity index is 6 then the final RGB-value is (0, (69/255)*160, (69/255)*30)=(0, 43, 8). In the embodiment in FIG. 3 is illustrated at the bottom six examples, where all the light emitting elements are the same colour and have the same intensity. The possible colours could be e.g. light blue, red, yellow, green, blue, purple, teal, pink, white, etc., which is illustrated in FIG. 3 as different shades of grey. All the light emitting elements 3 having the same colour and intensity is useful when the hub device 15 receives a signal from a connected building block device, for example a building block sensor 21, which outputs a discrete value to be visualized by the light matrix 5. The discrete single value is then visualized using the colour index as described above with all the light emitting elements 3 having the same colour.

The connected device, e.g. sensor 21, may send a signal formatted to conform with the encoding wherein the information to regulate the colour and intensity of each light emitting element 3 is encoded in a single byte of information. Alternatively, the connected device 21 sends its discrete value to the hub device 15 via the connection 23, and the hub device 15 then encodes the information for the light matrix building block 1. As a further alternative, or additionally, the light matrix building block 1 may be further configured to receive and decode the discrete value signal directly from the building block sensor 21 via the hub device 15 to produce the described visualization of the discrete value.

In the embodiment in FIG. 4, the building block device 13 is a simple building block battery device 23 that does not have the capability for digital communication. The light matrix building block 1 is configured to detect via the cable 7 that it is connected to a battery device that can supply it with power and further that the battery device is not configured for digital communication. When connected with this type of simple building block battery device 23, the light matrix building block 1 will detect the polarity of the battery and visualize it, for example by having all the light emitting elements 3 be a green colour for a positive polarity and a red colour for a negative polarity. At the bottom of FIG. 4 is illustrated three instances of the light matrix 5 with the light emitting elements 3 all having the same colour and intensity. To the far left the light matrix 5 is turned off before it is connected to the simple battery device 23, whereas the other two light matrices 5 represents the light matrix building block 1 detecting and visualizing either a positive or negative polarity by use of two different colours, illustrated as different shades of grey.

FIG. 5 shows an embodiment in which the light matrix building block 1 is connected to a building block device 13, which outputs a relative value that can be visualized as a value in a minus 10 to plus 10 range.

For example, the building block device 13 may be a smart battery device 25, i.e. a battery device that is capable of digital communication, or it may be a hub device 15. As described above in relation to FIG. 4, the light matrix building block 1 can detect if it is connected to a battery device 25 and detect the polarity of the battery device. The smart battery device 25 provides the digital information needed for the light matrix building block 1 to visualize the power level of the battery. For a positive polarity the colour may be green and to visualize the power level the intensity of the green colour could increase with increasing power level, for example as shown by the intensity increasing in each vertical line until reaching a maximum value. Similarly, a negative polarity may be shown using a red colour and increasing intensity to show increasing battery level. In this way a red or green bar graph for the power level is produced. In FIG. 5 the different colours and intensities are illustrated as different shades of grey.

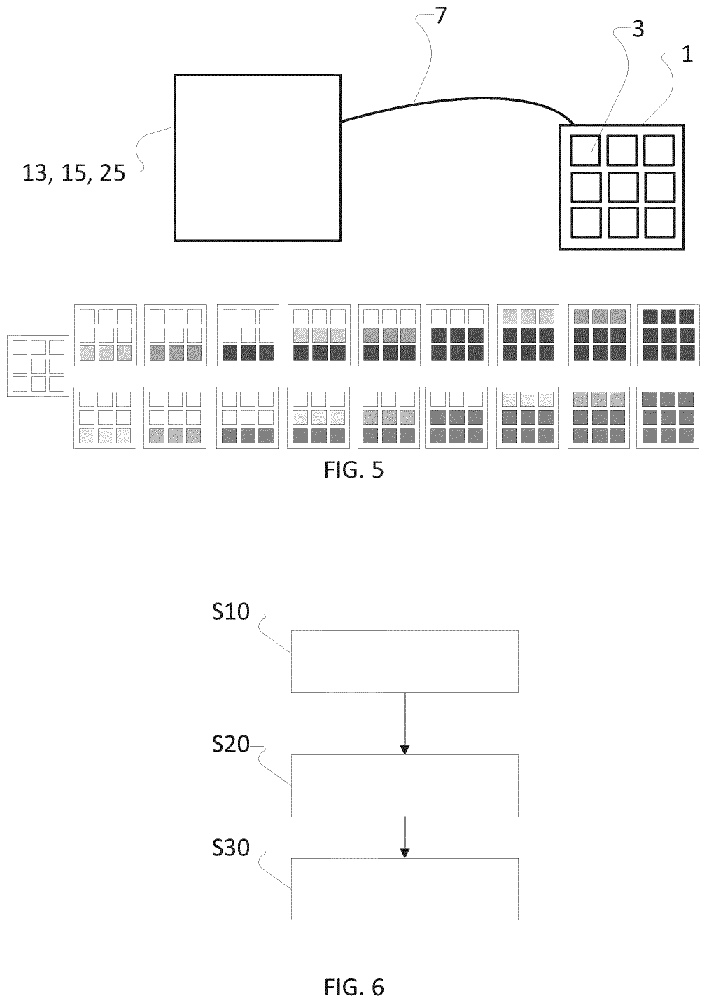

FIG. 6 shows a flow diagram of a method of communication between a light matrix building block 1 and a building block device 13 according to some embodiments. The light matrix building block 1 has a plurality of separate light emitting elements 3 and is configured to control the colour and intensity of each of the light emitting elements 3 individually.

In step S10, the building block device 13 provides digital information to the light matrix building block 1, where the digital information to regulate the colour and intensity of a light emitting element 3 in the plurality of light emitting elements is encoded in a single byte of information. The building block device 13 could be e.g. a building block hub device 15 or a building block smart battery device 25 as described in connection with FIGS. 2, 3 and 5. In step S20, the light matrix building block 1 receives and decodes the digital information and in step S30, the light matrix building block 1 regulates the colour and intensity of each of the light emitting elements 3 according to the digital information received.

The descriptions for FIGS. 1-5 provides examples of how the output from a building block device 13 may be visualized using the light matrix building block 1.

It will be appreciated by those of ordinary skill in the pertinent art that the functions of several elements can, in alternative embodiments, be carried out by fewer elements, or a single element. Similarly, in some embodiments, any functional element can perform fewer, or different, operations than those described with respect to the illustrated embodiment. Also, functional elements shown as distinct for purposes of illustration can be incorporated within other functional elements in a particular embodiment.

While the subject technology has been described with respect to various embodiments, those skilled in the art will readily appreciate that various changes and/or modifications can be made to the subject technology without departing from the scope of the present disclosure.

### LIST OF REFERENCE NUMBERS

1 Light matrix building block
3 Light emitting element
5 Matrix of light emitting elements
7 Connection cable
9 Connector
11 Attachment parts
13 Building block device
15 Building block hub device
17 Tablet
19 Wireless connection
21 Building block device outputting discrete value
23 Building block battery device
25 Building block smart battery device

What is claimed is:

1. A light matrix building block for a modular toy or educational construction set, the light matrix building block comprising a plurality of separate light emitting elements, the light matrix building block being configured to:
control the colour and intensity of each of the light emitting elements individually, and
receive and decode digital information to regulate the colour and intensity of each of the light emitting elements,
wherein the digital information to regulate the colour and intensity of a light emitting element in the plurality of light emitting elements is encoded in a single byte of information.

2. A light matrix building block according to claim 1, wherein the light matrix building block is further configured to decode digital information, wherein intensity and colour coded information is provided as an indexed intensity and indexed colour, respectively.

3. A light matrix building block according to claim 1, wherein the light matrix building block is further configured to decode digital information, wherein intensity coded information and colour coded information are each encoded in 4 bits.

4. A light matrix building block according to claim 1, wherein the plurality of light emitting elements are arranged on a 2D grid.

5. A light matrix building block according to claim 1, wherein the light matrix building block is further configured to receive the digital information via a wired connection.

6. A light matrix building block according to claim 1, wherein the light matrix building block is further configured to determine whether a connected building block device can provide power to an electronically connected building block, and whether it is configured for digital communication.

7. A light matrix building block according to claim 1, wherein the light matrix building block is further configured to regulate the colour and intensity of each of the light emitting elements according to a status of a connected building block device.

8. A modular toy or educational construction set comprising a light matrix building block according to claim 1 and a building block device, wherein the light matrix building block and the building block device are configured to be electronically connected with each other.

9. A modular toy or educational construction set according to claim 8, wherein the building block device is a building block hub device, which is configured to encode digital information intended for the light matrix building block.

10. A modular toy or educational construction set according to claim 8, wherein the building block device is a building block hub device, which is configured to wirelessly receive digital information intended for the light matrix building block.

11. A modular toy or educational construction set according to claim 10, wherein the building block hub device is further configured to receive the digital information intended for the light matrix building block as a single Bluetooth Low Energy (BLE) message.

12. A modular toy or educational construction set according to claim 8, wherein the building block device is a building block battery device.

13. A method of communication between a light matrix building block and a building block device, the light matrix building block comprising a plurality of separate light emitting elements, and being configured to control the colour and intensity of each of the light emitting elements individually, the method comprising:
providing, by the building block device, digital information to the light matrix building block,
receiving and decoding, by the light matrix building block, of the digital information,
regulating, by the light matrix building block, the colour and intensity of each of the light emitting elements according to the received digital information,
wherein the digital information to regulate the colour and intensity of a light emitting element in the plurality of light emitting elements is encoded in a single byte of information.

14. A method of communication according to claim 13, wherein the intensity and colour coded information is provided as an indexed intensity and indexed colour, respectively.

15. A method of communication according to claim 13, wherein the intensity coded information and colour coded information are each encoded in 4 bits.

16. A light matrix building system comprising:
a housing;
a matrix of light emitting elements disposed on the face of the housing; and
a controller housed within the housing, the controller configured to:
control the colour and intensity of each of the light emitting elements individually,
receive and decode digital information to regulate the colour and intensity of each of the light emitting elements, the digital information encoded in a single byte of information.

17. The light matrix building system according to claim 16, further comprising a building block hub processor configured for:
receiving digital information from a user device, the digital information intended for the light matrix building system; and
transmitting the digital information to the controller.

18. The light matrix building system according to claim 16, wherein the digital information to regulate the colour and intensity of each of the light emitting elements is provided as an indexed intensity and indexed colour, wherein four bits provide the index for the color and four bits provide the index for the intensity.

19. The light matrix building system according to claim 18, wherein the digital information to regulate the intensity of each of the light emitting elements is provided as a gamma-level table with the four bits providing the index for the level.
